(19) United States
(12) Patent Application Publication
(10) Pub. No.: US 2026/0202572 A1
(43) Pub. Date: Jul. 16, 2026

(54) METHOD AND SYSTEM FOR CALCULATING CLEAN AZIMUTH IN PRESENCE OF MAGNETIC INTERFERENCE FROM OFFSET WELLS DURING DRILLING OPERATIONS

(71) Applicant: Gunnar LLLP, Magnolia, TX (US)

(72) Inventors: Georgy Rassadkin, Bakersfield, CA (US); Clinton Moss, Bakersfield, CA (US); ARTHUR La Porta, Ventura, CA (US)

(73) Assignee: Gunnar LLLP, Magnolia, TX (US)

(21) Appl. No.: 19/442,153

(22) Filed: Jan. 7, 2026

Related U.S. Application Data
(60) Provisional application No. 63/745,030, filed on Jan. 14, 2025.

(51) Int. Cl. G01V 3/38; E21B 47/022; G01V 3/26

(52) U.S. Cl. CPC G01V 3/38; E21B 47/022; G01V 3/26

(57) ABSTRACT

Apparatuses and methods are disclosed for mitigating magnetic drill string interference in measurement-while-drilling systems. The system employs a central magnetic MWD sensor and one or more flanking sensors positioned axially above and below the central sensor. Measurements acquired from flanking sensors are used to characterize magnetic interference generated by ferromagnetic components of the drill string and BHA. Depending on the number and spacing of flanking sensors, the interference field is estimated using analytical techniques and/or numerical fitting methods to determine magnetic source strengths, source locations relative to the central sensor, and an axial component of the Earth's magnetic field. The estimated interference is used to correct magnetic measurements at the central MWD sensor, enabling improved azimuth accuracy without reliance on conventional correction techniques. Scalable sensor configurations of three or more sensors are supported, providing robust interference mitigation across a wide range of wellbore orientations, including horizontal East-West trajectories.

### FIELD OF THE INVENTION

The present disclosure relates to downhole surveying and magnetic measurement-while-drilling (MWD) systems, and particularly to apparatuses and methods for mitigating magnetic interference and improving azimuth accuracy using a variety of arrangements of sensor arrays.

### BACKGROUND INFORMATION

Magnetic interference from drill string components significantly impacts azimuth accuracy in MWD systems. Traditional correction techniques, such as “short collar” correction and multi-station correction (MSC), are based on knowledge of the background magnetic field, which is typically modeled. MSC further requires measurements to be collected at various toolface, inclination, and azimuth orientations to estimate the interference. However, these methods remain limited, particularly at or near horizontal East/West orientations. The current inventions introduce a scalable apparatus and methods with sensor configurations ranging from basic to advanced, offering comprehensive magnetic interference mitigation for accurate MWD surveying and directional drilling in all orientations.

### SUMMARY

The inventions disclosed herein address the limitations of conventional magnetic interference correction methods, and employs flanking sensors arranged in various configurations. The configurations range from basic single-pair setups to advanced multi-pair arrays. The methods disclosed herein provide a novel approach for calculating and estimating accurate azimuth measurements.

When only two flanking sensors are used—one above and one below the central MWD sensor—the system operates under the assumption that the distance to the interfering magnetic poles is known. In this simplified approach, the flanking sensors measure the magnetic field at their respective locations, and the interfering poles are characterized based on their pre-determined positions. When two pairs of flanking sensors are employed (e.g., two sensors above and two sensors below the central MWD sensor), the system can determine the distances to the interfering magnetic poles and their charges. This configuration addresses the limitations of the single-pair setup by allowing for a full characterization of the interfering poles using numerical fit techniques. Configurations with more than two pairs of flanking sensors provide redundant measurements and additional qualifiers for the accuracy of the numerical fit.

### BRIEF DESCRIPTION OF THE DRAWINGS

FIG. 1 is an example of a system with two flanking sensors pairs.

### DETAILED DESCRIPTION OF THE INVENTION

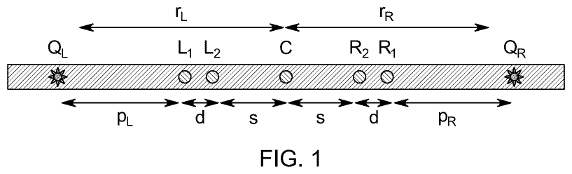

FIG. 1 illustrates an example of the system with two flanking sensor pairs and the positioning of the magnetic sources.

In FIG. 1, two charges QL and QR are distance r_{L} and r_{R} from the central sensor C in the MWD unit. There are pairs of flanking sensors on either side, L₁, L₂ and R₁ and R₂. S is the distance to the nearer of each flanking pair and the spacing between each of the flanking pairs is d. In one preferred embodiment, the flanking sensors are spaced at predetermined intervals to optimize detection of interference from nearby magnetic sources. The array of sensors in the flanking unit allows the variation of the field to be measured as a function of axial distance. Taking the central sensor C as the origin the right flanking sensors are at positions d and d+s, and the left flanking sensors are at positions −d and −d−s. The distance to the right source relative to the nearest flanking sensor is pr where r_{R}=ρ_{R}+d+s, and similarly r_{L}=−ρ_{L}−d−s. The magnetic sensors also detect the axial component of the Earth field BE.

The most rigorous way to evaluate the interference at the central MWD unit is to perform a fit where sensor locations are fixed, but the two charges have unknown strength Q_{L} and Q_{R} and unknown distance from the central sensor r_{L} and r_{R}. In this case, the model consists of five equations for the five axial B field measurements, expressed in terms of five unknowns (Q_{L}, Q_{R}, r_{L}, r_{R}, and B_{E}) requiring an advanced two-flanking-pair sensor configuration (a total of five sensors). A numerical search can be used to find the solution.

If the Earth's magnetic field (B_{E}) is known within reasonable uncertainty limits—such as through In-Field Referencing (IFR) or an advanced geomagnetic field model—the number of unknowns can be reduced from five to four. Additionally, knowledge of the distances between the sensors and the ferromagnetic components in the BHA could further enable the estimation of the location of the interfering local poles, allowing for a further reduction in the sensor layout to a basic single-flanking-pair configuration (a total of three sensors).

However, for best accuracy, especially at or near East/West horizontal orientations where uncertainty in the Earth's magnetic field (B_{E}) or local charge positions contribute to greater azimuth errors, the full five-parameter fit is required.

Each charge strength and location determined by flanking pair: Mathematically, the simplest way to obtain a solution would be to assume that each flanking pair is dominated by the nearby charge, although this condition may not typically be met because the Earth field cannot be assumed negligible compared to the interfering field. However, if the interfering source does dominate, the calculations can be simplified.

Assume there is a charge Q at distance r₁ from the first sensor and distance r₂ from the second sensor. This gives:

$${B}_{1} = \frac{kQ}{{r}_{1}^{2}} \qquad ( 1 )$$

$${B}_{2} = \frac{kQ}{{r}_{2}^{2}}$$

Dividing the two equations gives the following:

$$\frac{{B}_{1}}{{B}_{2}} = \frac{{r}_{2}^{2}}{{r}_{1}^{2}} \qquad ( 2 )$$

$$\frac{{r}_{1}}{{r}_{2}} = {( \frac{{B}_{r}}{{B}_{1}} )}^{1 / 2}$$

Next, substituting r₁=s, r₂=s+d in the second line of Equation 2 (see FIG. 1) gives the following:

$$\frac{s}{s + d} = {( \frac{{B}_{r}}{{B}_{1}} )}^{1 / 2} \qquad ( 3 )$$

$$s [ 1 - {( \frac{{B}_{r}}{{B}_{1}} )}^{1 / 2} ] = {d ( \frac{{B}_{r}}{{B}_{1}} )}^{1 / 2}$$

$$s = d ( \frac{{( \frac{{B}_{r}}{{B}_{1}} )}^{1 / 2}}{1 - {( \frac{{B}_{r}}{{B}_{1}} )}^{1 / 2}} )$$

Since d is known and B₁ and B₂ are measured values, there is an explicit formula for s, the distance to the source. Once s is known, Q can be obtained using the first of Equation 1.

$$Q = \frac{{s}^{2} {B}_{1}}{k} \qquad ( 4 )$$

For magnetic field in Tesla k is 1×10⁻⁷ to obtain Q in A-m.

Each charge strength, location and Earth field determined by flanking pair:

Although there may be cases where the field observed by a pair of sensors is negligibly affected by the pole on the opposite side, it is not likely that the Earth field can be neglected, unless the poles are right up against the flanking sensors. Taking into account the Earth field requires three measurements to obtain the strength and position of a charge. The calculations are shown below:

$${B}_{1} = \frac{kQ}{{r}_{1}^{2}} + {B}_{E} \qquad ( 5 )$$

$${B}_{2} = \frac{kQ}{{r}_{2}^{2}} + {B}_{E}$$

$${B}_{3} = \frac{kQ}{{r}_{3}^{2}} + {B}_{E}$$

Assuming r₁=s, r₂=s+d, and r₃=s+e, differences and ratios of B can be used to eliminate the Earth field and charge magnitude.

$$\frac{{B}_{1} - {B}_{2}}{{B}_{1} - {B}_{3}} = [ \frac{{( r + d )}^{2} - {r}^{2}}{{( r + d )}^{2} {r}^{2}} ] [ \frac{{( r + e )}^{2} {r}^{2}}{{( r + e )}^{2} - {r}^{2}} ] \qquad ( 6 )$$

This equation has only one variable, r, and can be solved numerically. Once r has been determined, the charge and Earth field can be evaluated

$$Q = ( \frac{1}{k} ) [ \frac{( {B}_{1} - {B}_{2} ) {( r + d )}^{2} {r}^{2}}{{( r + d )}^{2} {r}^{2}} ] \qquad ( 7 )$$

$${B}_{E} = {B}_{1} - \frac{kQ}{{r}^{2}}$$

This method of calculation requires three flanking sensors on each side, which entails a greater expense and complexity in the tool. To avoid increasing the complexity and cost of the tool, the need for an additional sensor can be eliminated by using a more capable analysis technique. Furthermore, the assumption that the contribution of the distant source can be neglected is not valid, given that the distant source has a significant effect on the central MWD sensor, which may be half as far away.

Given the above, the most optimal solution would be a numerical fit to the five magnetic field sensors, varying the five free parameters (Q_{L}, Q_{R}, r_{L}, r_{R} and B_{E}). This would give the necessary correction and produce the axial component of the Earth field as an output of the fit. The three-sensor solution in Equations 6 and 7 could be used to generate an initial value for optimization, using the proximal flanking pair and the central sensor to estimate the value of Q and r on each side. More than five sensors can be employed which can include additional sensors on each side of the central MWD sensor to perform a comprehensive fit of an interference model (Q_{L}, Q_{R}, r_{L}, r_{R} and B_{E}), whereas deviation between the measured data and the interference model is used to assess the quality of the interference field measurement. The interference model can be expanded to include more than one effective source on each side of the MWD unit and the number of sensors is expanded to be sufficient to determine the model parameters. The interference model can also be generalized to admit source charges extended over a finite distance and the number of sensors is expanded to be sufficient to determine model parameters.

Assuming charge locations known, strengths unknown:

A big simplification would be to assume that the locations of the two charges, r_{L} and r_{R}, are known, and only the charges Q_{L} and Q_{R} need to be determined. Assuming that each flanking pair is not influenced by the charge on the opposite side, the two B fields at the flanking pair would be sufficient to determine the nearby charge. Including the unknown Earth field, it gives:

$${B}_{1} = \frac{kQ}{{r}_{1}^{2}} + {B}_{E} \qquad ( 8 )$$

$${B}_{2} = \frac{kQ}{{r}_{2}^{2}} + {B}_{E}$$

$${B}_{2} - {B}_{1} = kQ ( \frac{1}{{r}_{2}^{2}} - \frac{1}{{r}_{1}^{2}} )$$

Solving for Q one gets:

$$Q = \frac{( {B}_{2} - {B}_{1} ) {r}_{1}^{2} {r}_{2}^{2}}{k ( {r}_{1}^{2} - {r}_{2}^{2} )} \qquad ( 9 )$$

where all parameters on the right-hand side are known.

If the assumption is not made that the charge on the opposite side is negligible, the process reverts to fitting using the five measured values of B, but with only three parameters. This approach allows the quality of fit to be used to evaluate the reliability of the calculation.

The scalable approach described mitigates the negative effects of magnetic interference on azimuth measurements in MWD systems. The basic configuration, with a single flanking pair of sensors, relies on the assumption that the flanking pair is influenced only by the nearest magnetic poles, and uses the BHA dimensions to derive the approximate location of these poles. The advanced system configurations and methods, which enable full characterization of the interference field without relying on these assumptions require an advanced five-parameter fit involving two or more flanking pairs of sensors.

The MWD unit may also contain one or more processors for processing signals received from any of the sensors described herein. Processors for processing the signals received from sensors may also be contained elsewhere in the drill string, or alternatively processors for processing signals may also be located on surface.

Methods using the herein described sensors are also described. The method involves measuring magnetic interference in downhole environments. The method involves measuring magnetic fields using a central MWD sensor and one or more groups of flanking sensors, determining the charge strengths Q_{L} and Q_{R} and distances r_{L} and r_{R} from the central MWD sensor using one or more fitting models and determining the earth field via an axial array of sensors. The interference can be calculated using a simplified model that assumes known charge locations r_{L} and r_{R} and treats the charge strengths Q_{L} and Q_{R} as unknown variables.

The method may also involve using a three parameter solution based on measurements from proximal flanking sensors and the central MWD sensor to generate an initial value for charge parameters and refining the initial value of the charge parameter generated using numerical optimization to achieve a minimum least squares deviation. Examples of numerical optimization methods that can be used are gradient descent, which iteratively adjusts parameters by moving in the direction of the steepest decrease (the negative gradient) of a function, commonly used to minimize error in machine learning models like neural networks, Newton's Method, which uses second derivatives (Hessian) for faster convergence, and the Nelder-Mead Simplex, a derivative-free method for complex functions.

The method may also provide real time feeback on interference parameters and direct azimuth calculations using the derived parameters during drilling operations. The method can be carried out using software, hardware, or a combination of both and may use one or more processors and one or more types of computer memory.

While the inventions herein have been illustrated and described in detail in the drawings and foregoing description, the same is to be considered as illustrative and not restrictive in character, it being understood that only the preferred embodiments have been shown and described and that all changes and modifications that come within the spirit of the invention are desired to be protected.

What is claimed is:

1. An apparatus for estimating axial magnetic interference in a downhole environment comprising:
a central magnetic measurement-while-drilling (MWD) sensor;
a flanking sensor positioned on each side of the central magnetic MWD sensor;
one or more processors configured to calculate interference parameters where magnetic sources of unknown strength are present at known locations above and below the central MWD sensor.

2. The apparatus of claim 1, wherein the flanking sensors positioned on each side of the central magnetic MWD comprises an array of sensors spaced at predetermined intervals.

3. The apparatus of claim 1 further comprising a configuration of at least four sensors in addition to the central MWD sensor.

4. The apparatus of claim 1 wherein the one or more processors is configured to perform a fit of an interference model using Q_{L}, Q_{R}, r_{L}, r_{R}, and B_{E}, where deviation between measured data and the interference model is used to assess the quality of the interference field measurement.

5. The apparatus of claim 2 further comprising flanking sensors that are spaced in order to optimize the impact of distant sources on magnetic field measurements.

6. The apparatus of claim 2 wherein the one or more processors is further configured to use data from an expanded array of five sensors to solve for charge strengths, charge locations and the axial component of the earth's magnetic field.

7. The apparatus of claim 2, wherein an interference model is expanded to include more than one effective source on each side of the central MWD unit and the number of sensors is expanded to be sufficient to determine the model parameters.

8. The apparatus of claim 2, wherein an interference model is generalized to admit source charges extended over a finite distance and the number of sensors is expanded to be sufficient to determine the model parameters.

9. A method for measuring magnetic interference in a downhole environment comprising:
measuring magnetic fields using a central MWD sensor and flanking sensors;
determining charge strengths (Q_{L}, Q_{R}) and distances (r_{L}, r_{R}) relative to the central MWD sensor through a fitting model;
determining the earth field (B_{E}) using the determined charge strengths and the data acquired from the central MWD sensor and the flanking sensors.

10. The method of claim 9, further comprising calculating an interference using a simplified model that assumes known charge locations (r_{L}, r_{R}) and treats charge strengths (Q_{L}, Q_{R}) as unknown variables.

11. The method of claim 9, further comprising measuring magnetic fields from three flanking sensors on each side of the central MWD sensor and using the acquired data to calculate an interference that accounts for contributions from the Earth's magnetic field and interference from distant magnetic sources.

12. The method of claim 9 further comprising providing real-time feedback on interference parameters and direct azimuth calculations during drilling operations.

13. The method of claim 10 further comprising providing real-time feedback on interference parameters and direct azimuth calculations during drilling operations.

14. The method of claim 11 further comprising providing real-time feedback on interference parameters and direct azimuth calculations during drilling operations.

15. A method for calculating magnetic interference, comprising:
using a three-parameter solution based on measurements from proximal flanking sensors and a central MWD sensor to generate an initial estimate for charge parameters;
refining the initial estimate for charge parameters using numerical optimization to achieve a minimum least-squares deviation.

16. The method of claim 15 further comprising estimating interference parameters using differences and ratios of measured magnetic field values to eliminate the earth's magnetic field contribution.
